(19) United States
(12) Patent Application Publication
(10) Pub. No.: US 2009/0136147 A1
(43) Pub. Date: May 28, 2009

(54) METHOD FOR COMPRESSING IMAGE DATA

(75) Inventors: Wen-Bin Liau, Hsinchu (TW); Wei-Sheng Wang, Hsinchu (TW)

Correspondence Address: WPAT, PC;INTELLECTUAL PROPERTY ATTORNEYS, 2030 MAIN STREET, SUITE 1300, IRVINE, CA, 92614, US

(73) Assignee: FOXLINK IMAGE TECHNOLOGY CO., LTD., Hsinchu (TW)

(21) Appl. No.: 11/945,140

(22) Filed: Nov. 26, 2007

(51) Int. Cl. G06K 9/36

(52) U.S. Cl. 382/246; 382/250

(57) ABSTRACT

A method for compressing image data is used to process image data. The method includes the following steps as sampling pixels expressing an image, transforming the sampling data into transformed data by forward discrete cosine transformation, quantifying the transformed data according to a quantification table into quantified data, encoding the quantified data according to Huffman table, and generating a frame data. When the frame data is processed along the reverse pipeline, the frame data is decompressed to the image data.

### BACKGROUND OF THE INVENTION

1. Field of the Invention

This present invention relates to a method for processing image data, and more specifically to a method for compressing image data.

2. The Related Art

Conventionally, an image is composed by lots of pixels. Each pixel includes a red value, a green value and a blue value. Different pixels would present different colors based on the different combination of the red, green and blue values contained in each pixel.

In the process of image transmission, millions of pixels are compressed and further decompressed to restore the image. The image compression technology is used to transform an image into a series of data which occupies a small memory capacity. The compressed data can be decompressed to restore the image by the decompression technology. A Joint Picture Experts Group developed a JEPG compression standard. Generally, the JEPG has a YCrCb format.

In FIG. 1, a standard JEPG compression process includes:
step A, capturing RGB image data about an image;
step B, transforming the RGB image data to YCrCb data, the transforming formula being:

Y=0.2990R+0.5890G+0.1140B,

Cb=−0.1687R−0.3313G+0.5000B+128,

Cr=0.5000R−0.4187G−0.0813B+128,
wherein, the R, G and B is respectively equal to the red, green and blue values of the corresponding pixel before the image is transformed, the Y is used to indicate the luminance value of the pixel, the Cb and Cr is used to indicate a red chrominance value and a blue chrominance value of the chrominance value of the pixel;
step C, sampling the YCrCb data, wherein the sampling format may also be 4:2:2 or 4:2:1, take 4:2:1 as an example, the luminance values of the four pixels adjacent each other are sampled, the red chrominance values of two of the four pixels are sampled, the blue chrominance value of one of the four pixels is sampled;
step D, transforming the sampled YCrCb data by a forward discrete cosine transformation, wherein the digital data about the image is transformed to frequency coefficient;
step E, quantifying the transformed data according to a quantification table into quantified data, to reduce the ratio of non-zero values and increase the ratio of zero values in the frequency coefficients;
step F, encoding the quantified data of the image according to Huffman table to compress the data of the image; and
step G, transforming the coded data into a frame data, then a JPEG data being output to store conveniently.

The traditional method for decompressing image data is the reverse of the method for compressing image data. Accordingly, an image has millions of pixels which must be compressed and then decompressed for transferring and receiving the image, so the time spent in the compression and decompression is very long, the gain of the image is delayed. And for many processing steps of the traditional compressing and decompressing method of image data, the quality of the image will be abated in compression and decompression.

### SUMMARY OF THE INVENTION

The invention is to provide a method for compressing image data, the compressing method includes: capturing pixels of an image; sampling the pixels of the image to form digital data, the sampling rate of the pixels being 4:4:4; transforming the digital data of the image into transformed data by a forward discrete cosine transformation; quantifying the transformed data according to a quantification table into quantified data; encoding the quantified data of the image according to Huffman table; and generating a frame data.

As above description, the steps of the method for compressing image data are less than a traditional method for compressing image data. In the same way, a method for decompressing image data is the reverse of the method for compressing image data and less than a traditional method for decompressing image data. Then, the time of processing image data is reduced, and the quality of the image data is less disturbed in compression, so an image is compressed and then decompressed to obtain a high-quality RGB image.

### BRIEF DESCRIPTION OF THE DRAWINGS

The invention, together with its objects and the advantages thereof may be best understood by reference to the following description taken in conjunction with the accompanying drawings, in which:

FIG. 1 is a flowchart showing a traditional method for processing image data;

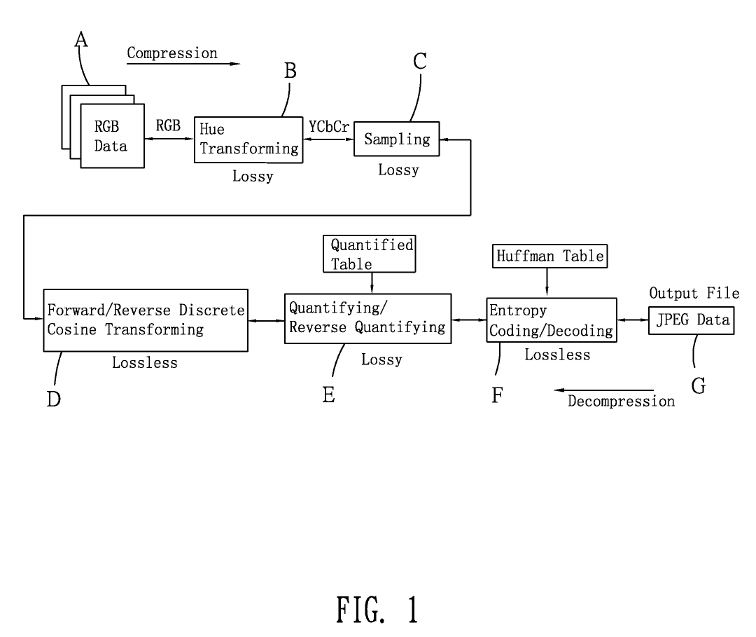

FIG. 2 is a flowchart showing a method for compressing image data according to the present invention; and

FIG. 3 is a flowchart showing a method for decompressing image data in accord with the method for compressing image data.

### DETAILED DESCRIPTION OF THE PREFERRED EMBODIMENT

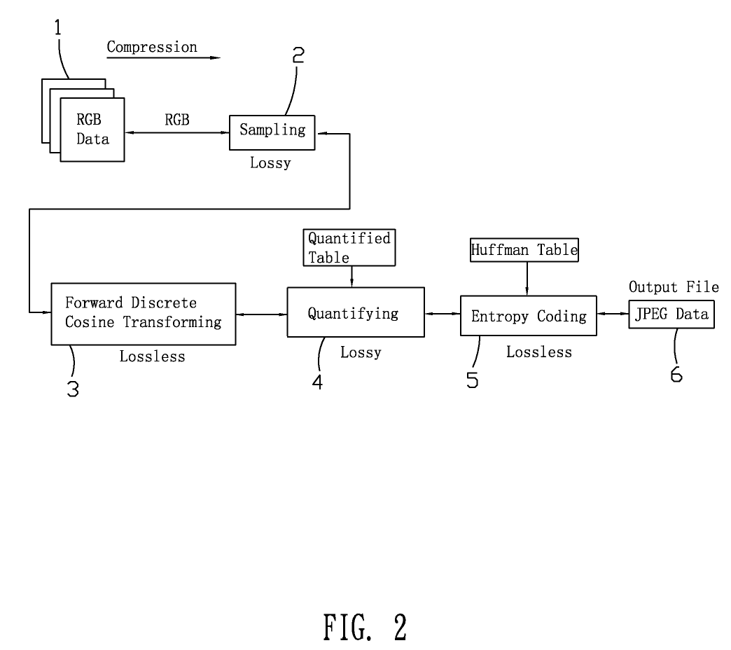

Referring to FIG. 2, a method for compressing image data includes:
step 1, capturing an original image, wherein the original image is an image data expressed in RGB format, every pixel of the image includes a red value, a green value and a blue value, the red value, the green value and the blue value are 8-bit unsigned numerals, when the three values are different numerals, the pixel corresponding to the three values can display different color;
step 2, sampling pixels of the original image to form digital data, wherein the present invention is different from the standard JEPG method, the red value, the blue value and the green value do not be transformed to frequency coefficients, so the detail of the original image is remained, the luminance value of the image does not lose especially, and wherein the sampling rate is 4:4:4, the luminance values of the four pixels adjacent each other are sampled, the red chrominance values of the four pixels are sampled, the blue chrominance values of the four pixels are sampled;
step 3, transforming the digital data of the image into transformed data by a forward discrete cosine transformation, wherein the digital data gained by sampling in step 2 is 8×8 pixel blocks which are transformed respectively;
step 4, quantifying the transformed data by step 3 according to an quantification table into quantified data;
step 5, encoding the quantified data according to Huffman table; and
step 6, transforming the coded data into a frame data, then JPEG data being output.

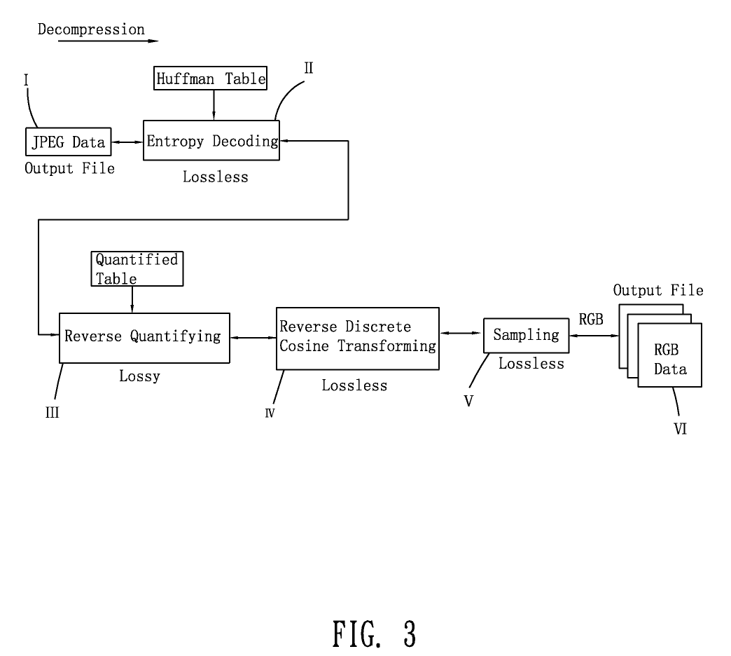

Please Referring to FIG. 3, a decompressing method is the reverse of the compressing method. The method for decompressing image data includes:
step I, capturing JPEG data;
step II, decoding the JPEG data according to Huffman table;
step III, reverse quantifying the decoded data according to the quantification table set in advance;
step IV, reverse discrete cosine transforming the reverse quantified data;
step V, restoring the reverse discrete cosine transformed data to a series of pixels; and
step VI, composing the pixels into an image.

In this embodiment, the steps of the method for compressing and decompressing image data is less than a traditional method for compressing and decompressing image data, so the time of processing image data is reduced, and the quality of the image data is less disturbed in compression and decompression, so an image is compressed and then decompression to obtain a high-quality RGB image.

An embodiment of the present invention has been discussed in detail. However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. A method for compressing image data, comprising the steps of:
capturing pixels of an image;
sampling the pixels of the image to form digital data, the sampling rate of the pixels being 4:4:4;
transforming the digital data of the image into transformed data by a forward discrete cosine transformation;
quantifying the transformed data according to a quantification table into quantified data;
encoding the quantified data of the image according to Huffman table; and
generating a frame data.

2. The method for compressing image data as set forth in claim 1, wherein the digital data sampled is 8×8 pixel blocks which are is forward discrete cosine transformed respectively.
